(19) United States
(12) Patent Application Publication
(10) Pub. No.: US 2025/0091499 A1
(43) Pub. Date: Mar. 20, 2025

(54) WORK VEHICLE

(71) Applicant: KUBOTA CORPORATION, Osaka (JP)

(72) Inventor: Connor HENDERSON, Gainesville, GA (US)

(73) Assignee: KUBOTA CORPORATION, Osaka (JP)

(21) Appl. No.: 18/370,104

(22) Filed: Sep. 19, 2023

(51) Int. Cl. B60P 1/16; F15B 13/02; F16H 57/02

(52) U.S. Cl. CPC B60P 1/162; F15B 13/024; F16H 57/02; F16H 2057/02026; F16H 2057/02043

(57) ABSTRACT

A work vehicle includes a body, a carrier box provided for the body and configured to be lifted and lowered, a fluid cylinder configured to operate the carrier box, a pump configured to supply working fluid into the fluid cylinder, and a control valve unit including a control valve configured to control supply and discharge of working fluid into and from the fluid cylinder.

### TECHNICAL FIELD

The present disclosure relates to a work vehicle such as a utility terrain vehicle (UTV) including a body with a carrier box.

### BACKGROUND ART

UTVs are used as four-wheel drive off-road vehicles for multiple purposes such as farmwork and transportation. A UTV may include a carrier box switchable between a horizontal position and a slanted position with a front portion lifted in response to an operation of a dump cylinder.

### SUMMARY OF INVENTION

There has been a demand for a UTV capable of moving and stopping its carrier box appropriately.

A work vehicle according to the present disclosure includes:
a body;
a carrier box provided for the body and configured to be lifted and lowered;
a fluid cylinder configured to operate the carrier box;
a pump configured to supply working fluid into the fluid cylinder; and
a control valve unit including:
   a control valve configured to control supply and discharge of working fluid into and from the fluid cylinder;
   a supply and discharge flow passage disposed between the control valve and the fluid cylinder and configured to let, flow through the supply and discharge flow passage, working fluid to be supplied into the fluid cylinder and working fluid discharged from the fluid cylinder; and
   a relief valve disposed on the supply and discharge flow passage and switchable between (i) a block position, in which the relief valve blocks the supply and discharge flow passage, and (ii) a relief position, in which the relief valve permits working fluid to flow from a side of the fluid cylinder toward the control valve.

The work vehicle may be further configured such that the supply and discharge flow passage includes: a supply flow passage portion configured to let, flow through the supply flow passage portion, working fluid to be supplied into the fluid cylinder; and a discharge flow passage portion configured to let, flow through the discharge flow passage portion, working fluid discharged from the fluid cylinder, and the relief valve is disposed on the discharge flow passage portion. The work vehicle may further include: a check valve disposed on the supply flow passage portion and configured to permit working fluid to flow from a side of the control valve toward the fluid cylinder and prevent working fluid from the fluid cylinder from flowing toward the control valve. The work vehicle may be further configured such that the control valve unit includes: a pump port through which working fluid from the pump flows into the control valve unit; a discharge port through which working fluid is discharged from the control valve unit; and a cylinder port through which working fluid flows out of the control valve unit toward the fluid cylinder and through which working fluid flows from the side of the fluid cylinder into the control valve unit. The work vehicle may further include: an adjuster disposed on an outer wall of the control valve unit and configured to adjust a relief pressure of the relief valve. The work vehicle may further include: a transmission case at a back portion of the body, wherein the control valve unit is fixed to a lateral portion of the transmission case such that the adjuster faces backward relative to the body.

A work vehicle according to the present disclosure includes:
a body;
a carrier box provided for the body and configured to be lifted and lowered;
a fluid cylinder configured to operate the carrier box, the fluid cylinder including: a first working fluid chamber; and a second working fluid chamber;
a pump configured to supply working fluid into the fluid cylinder; and
a control valve unit including:
   a control valve configured to control supply and discharge of working fluid into and from the fluid cylinder;
   a first supply and discharge flow passage between the control valve and the first working fluid chamber;
   a second supply and discharge flow passage between the control valve and the second working fluid chamber;
   a first relief valve disposed on the first supply and discharge flow passage and switchable between (i) a block position, in which the first relief valve blocks the first supply and discharge flow passage, and (ii) a relief position, in which the first relief valve permits working fluid to flow from a side of the first working fluid chamber toward the control valve; and
   a second relief valve disposed on the second supply and discharge flow passage and switchable between (i) a block position, in which the second relief valve blocks the second supply and discharge flow passage, and (ii) a relief position, in which the second relief valve permits working fluid to flow from a side of the second working fluid chamber toward the control valve,
the control valve being switchable between
a first position, in which the control valve permits working fluid from the pump to be supplied into the first supply and discharge flow passage and working fluid from the second supply and discharge flow passage to be discharged,
a second position, in which the control valve permits working fluid from the pump to be supplied into the second supply and discharge flow passage and working fluid from the first supply and discharge flow passage to be discharged, and
a third position, in which the control valve blocks the first and second supply and discharge flow passages.

The work vehicle may be further configured such that the first supply and discharge flow passage includes: a first supply flow passage portion configured to let, flow through the first supply flow passage portion, working fluid to be supplied into the first working fluid chamber; and a first discharge flow passage portion configured to let, flow through the first discharge flow passage portion, working fluid discharged from the first working fluid chamber, the first relief valve is disposed on the first discharge flow passage portion, the second supply and discharge flow passage includes: a second supply flow passage portion configured to let, flow through the second supply flow passage portion, working fluid to be supplied into the second working fluid chamber; and a second discharge flow passage portion configured to let, flow through the second discharge flow passage portion, working fluid discharged from the second working fluid chamber, and the second relief valve is disposed on the second discharge flow passage portion. The work vehicle may further include: a first check valve disposed on the first supply flow passage portion and configured to permit working fluid to flow from a side of the control valve toward the first working fluid chamber and prevent working fluid from a side of the first working fluid chamber from flowing toward the control valve; and a second check valve disposed on the second supply flow passage portion and configured to permit working fluid to flow from the side of the control valve toward the second working fluid chamber and prevent working fluid from a side of the second working fluid chamber from flowing toward the control valve. The work vehicle may be further configured such that the control valve unit includes: a pump port through which working fluid from the pump flows into the control valve unit: a discharge port through which working fluid is discharged from the control valve unit; a first cylinder port through which working fluid flows out of the control valve unit toward the first working fluid chamber and through which working fluid flows from the side of the first working fluid chamber into the control valve unit; and a second cylinder port through which working fluid flows out of the control valve unit toward the second working fluid chamber and through which working fluid flows from the side of the second working fluid chamber into the control valve unit. The work vehicle may further include: an adjuster disposed on an outer wall of the control valve unit and configured to adjust a relief pressure of the first relief valve; and an adjuster disposed on the outer wall of the control valve unit and configured to adjust a relief pressure of the second relief valve. The work vehicle may further include: a transmission case at a back portion of the body, the control valve unit is fixed to a lateral portion of the transmission case in such a manner that the adjusters face backward relative to the body.

With the above configuration, the relief valve(s) allows working fluid to relieve pressure of working fluid from the side of the fluid cylinder toward the control valve in response to pressure building up in a supply and discharge flow passage while the fluid cylinder is at rest. This prevents the fluid cylinder from being operated unintentionally, and thereby prevents the carrier box at rest from being operated as such.

### BRIEF DESCRIPTION OF DRAWINGS

The present disclosure is further described in the detail description which follows, in reference to the noted plurality of drawings by way of non-limiting examples of exemplary embodiments of the present disclosure, in which like reference numerals represent similar parts throughout the several views of the drawings, and wherein:

FIG. 1 is a side view of a work vehicle.

FIG. 2 is a diagram of a hydraulic circuit including a valve unit in a neutral position.

FIG. 3 is a diagram of a hydraulic circuit including a valve unit in a lifted position.

FIG. 4 is a diagram of a hydraulic circuit including a valve unit in a lowered position.

FIG. 5 is a detailed diagram of a structure for attachment of a valve unit.

FIG. 6 is a detailed diagram of a valve unit.

### DESCRIPTION OF EMBODIMENTS

The description below deals with a work vehicle as an embodiment of the present disclosure with reference to drawings. The present embodiment described below is, as an example work vehicle, a utility terrain vehicle (UTV) including a body with a carrier box. The present disclosure is, however, not limited to the embodiment below, and may be altered variously within its scope.

The description below uses terms such as “front” and “forward” to refer to the front side in the front-back direction of the body (indicated as “F” in the drawings), terms such as “back” and “backward” to refer to the back side in the front-back direction of the body (indicated as “B” in the drawings), terms such as “left-right direction” and “lateral” to refer to the horizontal direction perpendicular to the front-back direction of the body, terms such as “below” and “downward” to refer to the gravitational direction (indicated with “D” in the drawings), and terms such as “above” and “upward” to refer to the direction opposite to the gravitational direction (indicated with “U” in the

### DRAWINGS

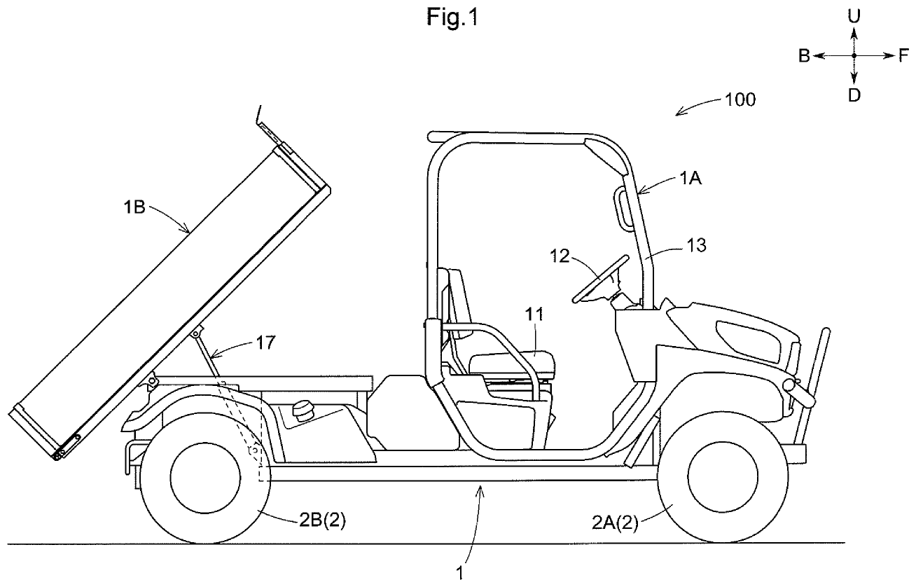

FIG. 1 illustrates a UTV 100 (which is an example of the “work vehicle”) including a body 1 and four wheels 2 (namely, two front wheels 2A and two rear wheels 2B) each supported by the body 1 with a suspension in-between. The UTV 100 is a four-wheel drive vehicle configured such that the wheels 2 are drivable by a power source such as a motor and an internal combustion engine. The UTV 100 is usable for multiple purposes such as farmwork and transportation.

The body 1 is provided with a pair of left and right front wheels 2A at a front portion and a pair of left and right rear wheels 2B at a back portion. The body 1 includes a driver section 1A backward of the front wheels 2A and a carrier box 1B backward of the driver section 1A. The carrier box 1B is configured such that a front portion thereof is liftable for a slanted position in response to an operation of a dump cylinder 17 (which is an example of the “fluid cylinder”) to allow a load to be dumped backward by its self weight.

The driver section 1A includes a driver's seat 11 for a driver to sit on and a steering wheel 12 positioned forward of the driver's seat 11 and operable to turn the front wheels 2A. The driver section 1A further includes two ROPS frames 13 respectively at the left and right sides of the driver section 1A to protect the driver and any other occupant in the event of a roll-over accident of the body 1.

The UTV 100 includes a working fluid circuit (which is an example of the “hydraulic circuit”) including a hydraulic pump 22, a control valve unit 8, and a dump cylinder 17 and configured to cause the carrier box 1B to dump its load.

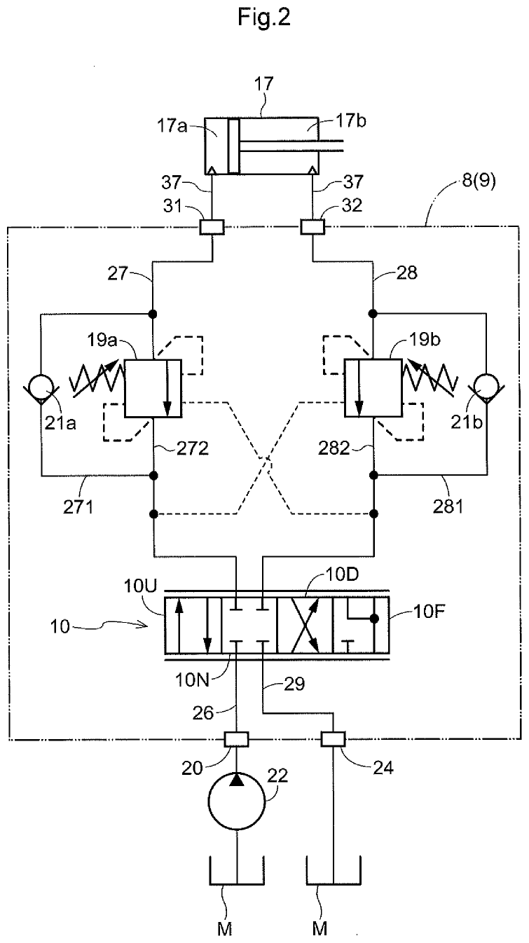

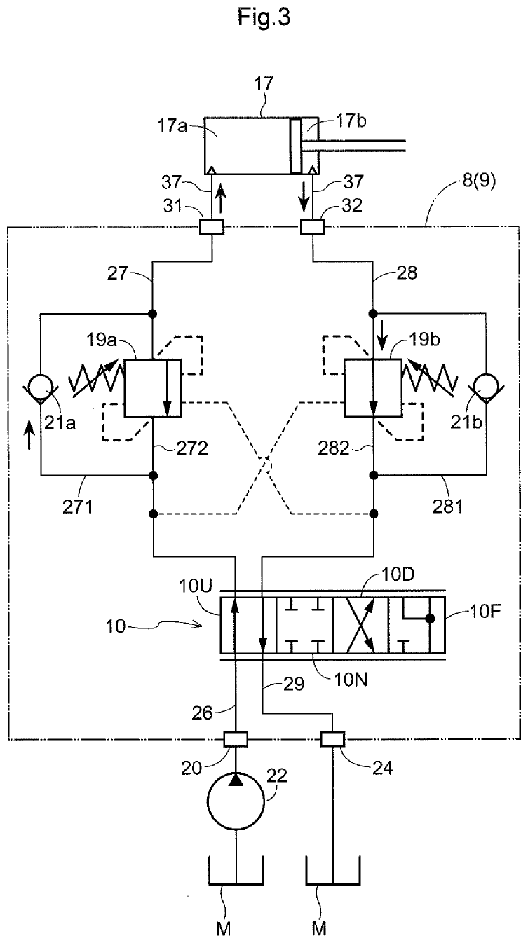

The description below deals with the control valve unit 8, which is configured to supply and discharge working oil (which is an example of the “working fluid”) to and from the dump cylinder 17. As illustrated in FIGS. 2 and 3, the control valve unit 8 includes a block-shaped valve case 9, and also includes in the valve case 9 a control valve 10, two relief valves 19a and 19b, and two check valves 21a and 21b.

The valve case 9 has a pump port 20, a discharge port 24, a first cylinder port 31, and a second cylinder port 32.

The control valve unit 8 includes oil passages (“flow passage”) such as a supply oil passage 26, a discharge oil passage 29, a first supply and discharge oil passage 27 (“first supply and discharge flow passage”), and a second supply and discharge oil passage 28 (“second supply and discharge flow passage”). The supply oil passage 26 extends from the pump port 20 to the control valve 10. The discharge oil passage 29 extends from the discharge port 24 to the control valve 10. The first supply and discharge oil passage 27 extends from the control valve 10 to the first port 31. The second supply and discharge oil passage 28 extends from the control valve 10 to the second port 32.

The first supply and discharge oil passage 27 branches out partway into a supply oil passage 271 (“first supply flow passage”) and a discharge oil passage 272 (“first discharge flow passage”), which merge with each other at a downstream position. The second supply and discharge oil passage 28 branches out partway into a supply oil passage 281 (“second supply flow passage”) and a discharge oil passage 282 (“second discharge flow passage”), which merge with each other at a downstream position.

The control valve 10 is switchable at least into a lifted position 10U, a lowered position 10D, or a neutral position 10N. In the lifted position 10U (“first position”), the control valve 10 allows working oil to be supplied from the pump 22 into the first supply and discharge oil passage 27 and discharged from the second supply and discharge oil passage 28. In the lowered position 10D (“second position”), the control valve 10 allows working oil to be supplied from the pump 22 into the second supply and discharge oil passage 28 and discharged from the first supply and discharge oil passage 27. In the neutral position 10N (“third position”), the control valve 10 blocks the first and second supply and discharge oil passages 27 and 28.

The supply oil passages 271 and 281 are provided with check valves 21a and 21b (“first check valve”, “second check valve”), respectively, each of which is configured to permit working oil to flow from the side of the control valve 10 toward the dump cylinder 17 and prevent working oil from flowing in the opposite direction.

The discharge oil passages 272 and 282 are provided with relief valves 19a and 19b (“first relief valve”, “second relief valve”), respectively, each switchable between a block position and a relief position. In the block position, the relief valve 19a, 19b blocks the corresponding discharge oil passage 272, 282. In the relief position, the relief valve 19a, 19b permits working oil to flow from the side of the dump cylinder 17 toward the control valve 10.

The description below deals with how to operate the carrier box 1B with use of the control valve unit 8 configured as above. The carrier box 1B may be moved by any means, and is moved with use of an operation tool such as a lever or a switch.

FIG. 2 illustrates the control valve 10 as being in a neutral position 10N. In this state, the first and second supply and discharge oil passages 27 and 28 are blocked, so that no working oil is supplied from the hydraulic pump 22 to the dump cylinder 17 and that no working oil is discharged from oil chambers 17a and 17b (“first working fluid chamber”, “second working fluid chamber”) of the dump cylinder 17. This causes the dump cylinder 17, and hence the carrier box 1B, to be at rest.

Suppose, for instance, loading an object into the carrier box 1B with the carrier box 1B at rest (that is, the control valve 10 in the neutral position 10N) horizontally. The object will increase the load on the carrier box 1B, which may cause trapped pressure in the supply and discharge oil passage 27 or 28. If, for instance, the control valve unit 8 did not include relief valves 19a and 19b as conventional, the trapped pressure could accidentally operate the dump cylinder 17 and thereby move the carrier box 1B.

The present embodiment is, in contrast, configured such that such trapped pressure leads to pressure in the respective pilot oil passages of the relief valves 19a and 19b, which in turn moves each of the relief valves 19a and 19b into the relief position, thereby allowing the trapped pressure to escape. This prevents the carrier box 1B from being moved accidentally.

As illustrated in FIG. 3, with the control valve 10 in a lifted position 10U, working oil is supplied from the hydraulic pump 22 through the pump port 20, the supply oil passage 26, the control valve 10, the first supply and discharge oil passage 27 (via the supply oil passage 271), the first port 31, and a hydraulic hose 37 into the oil chamber 17a of the dump cylinder 17. This operation generates hydraulic pressure in the pilot oil passage of the relief valve 19b, and thereby switches the relief valve 19b into the relief position. Working oil is then discharged from the oil chamber 17b of the dump cylinder 17 through a hydraulic hose 37, the second port 32, the second supply and discharge oil passage 28 (via the discharge oil passage 282), the relief valve 19b, the control valve 10, and the discharge port 24. This expands the dump cylinder 17 and lifts the carrier box 1B.

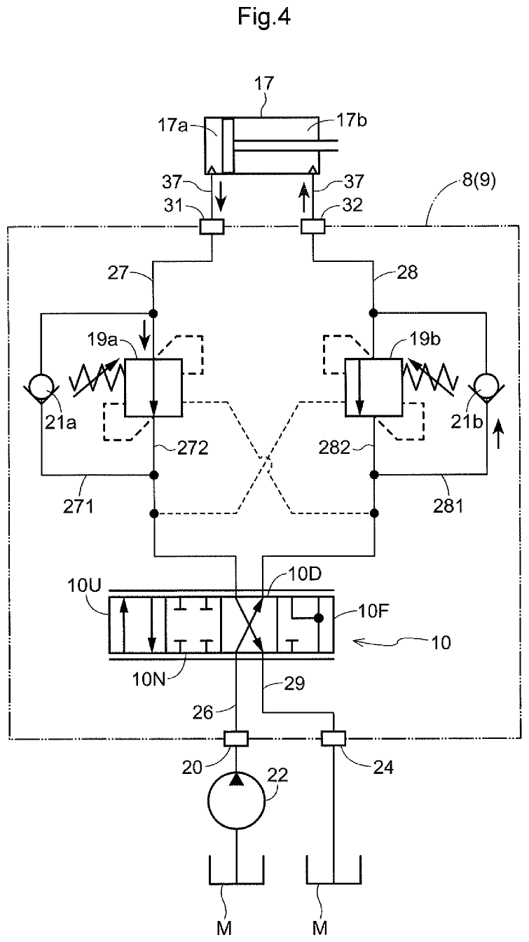

As illustrated in FIG. 4, with the control valve 10 in a lowered position 10D, working oil is supplied from the hydraulic pump 22 through the pump port 20, the supply oil passage 26, the control valve 10, the second supply and discharge oil passage 28 (via the supply oil passage 281), the second port 32, and a hydraulic hose 37 into the oil chamber 17b of the dump cylinder 17. This operation generates hydraulic pressure in the pilot oil passage of the relief valve 19a, and thereby switches the relief valve 19a into the relief position. Working oil is then discharged from the oil chamber 17a of the boom cylinder through a hydraulic hose 37, the first port 31, the first supply and discharge oil passage 27 (via the discharge oil passage 272), the relief valve 19a, the control valve 10, and the discharge port 24. This contracts the dump cylinder 17 and lowers the carrier box 1B.

With the control valve 10 in a manual operation position 10F, the first and second supply and discharge oil passages 27 and 28 are not in communication with the supply oil passage 26, and are in communication with the discharge oil passage 29. This allows a person to manually lift and lower the carrier box 1B. Specifically, applying force to the carrier box 1B against the urging force of the spring S of each relief valve 19a, 19b lifts and lowers the carrier box 1B. During this operation, the dump cylinder 17 functions as a damper to allow the carrier box 1B to be lifted and lowered gently.

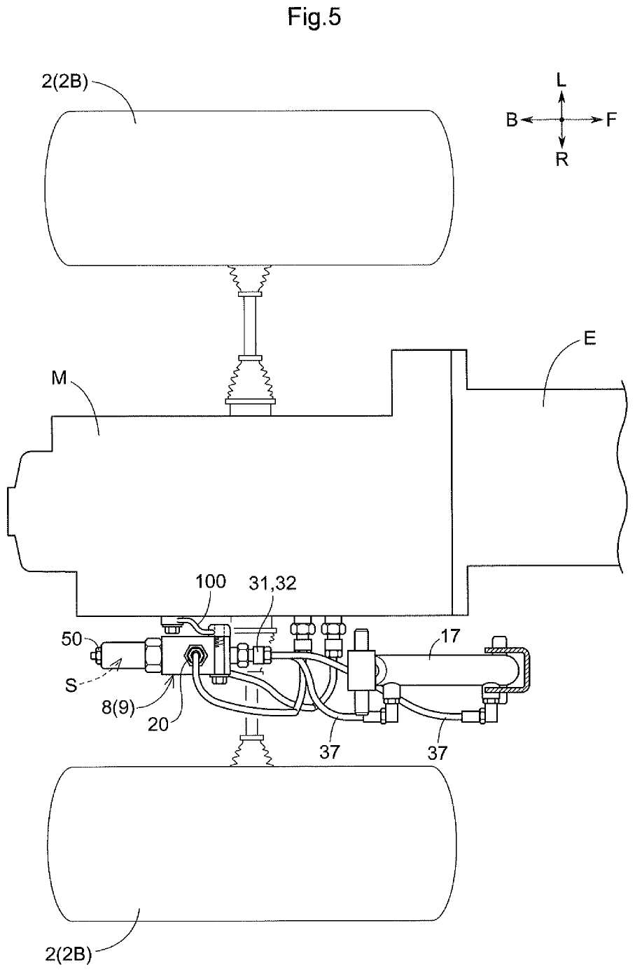

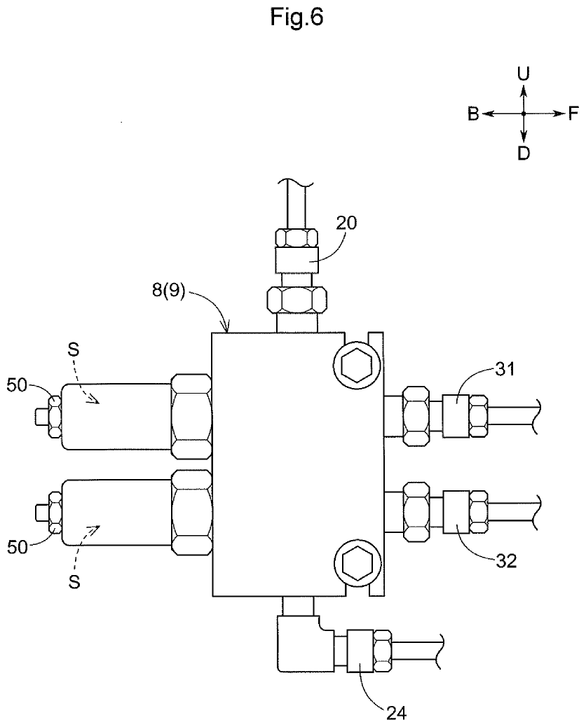

As illustrated in FIGS. 5 and 6, The relief valves 19a and 19b are each normally in the block position due to the urging force of its spring S. Hydraulic pressure in the pilot oil passage switches the relief valve 19a, 19b into the relief position against the urging force of its spring S. The control valve unit 8 includes an adjustment mechanism configured to adjust the urging force of each spring S and including adjustment nuts 50 (“adjuster”) on an outer surface of the valve case 9. Fastening and loosening each adjustment nut 50 adjusts the urging force of the corresponding spring S, thereby adjusting the level of hydraulic pressure at which the relief valve 19a, 19b is switched from the block position into the relief position.

As illustrated in FIGS. 5 and 6, the control valve unit 8 (or the valve case 9) is at a back lateral portion of the body 1. Specifically, while the body 1 is provided with an engine E at a back portion thereof and a transmission case M backward of the engine E, the control valve unit 8 is fixed to a lateral portion of the transmission case M with a bracket 100 in-between. The control valve unit 8 is oriented such that the adjustment nuts 50 face backward relative to the body 1 and arranged in the up-down direction. The adjustment nuts 50 face backward between the transmission case M and the rear wheels 2B.

### ALTERNATIVE EMBODIMENTS

(1) The work vehicle described above is not limited to a utility terrain vehicle (UTV), and may alternatively be, for example, a vehicle with a carrier box such as a pickup truck as long as the vehicle is capable of, for example, farmwork and transportation.

(2) The control valve unit described above does not necessarily include a single valve case 9 containing different components, and may alternatively include two or more valve cases containing those components and connected to each other with use of a hose, a pipe, or the like. The valve case(s) does not necessarily contain all the components, and may alternatively contain only one or more (but not all) components. The control valve unit may alternatively include no valve case.

(3) The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present disclosure is not limited to those embodiments, and may be altered as appropriate, as long as such an alteration does not result in a failure to attain an object of the present disclosure.

1. A work vehicle, comprising:
a body;
a carrier box provided for the body and configured to be lifted and lowered;
a fluid cylinder configured to operate the carrier box;
a pump configured to supply working fluid into the fluid cylinder; and
a control valve unit including:
a control valve configured to control supply and discharge of working fluid into and from the fluid cylinder;
a supply and discharge flow passage disposed between the control valve and the fluid cylinder and configured to let, flow through the supply and discharge flow passage, working fluid to be supplied into the fluid cylinder and working fluid discharged from the fluid cylinder; and
a relief valve disposed on the supply and discharge flow passage and switchable between (i) a block position, in which the relief valve blocks the supply and discharge flow passage, and (ii) a relief position, in which the relief valve permits working fluid to flow from a side of the fluid cylinder toward the control valve.

2. The work vehicle according to claim 1, wherein
the supply and discharge flow passage includes:
a supply flow passage portion configured to let, flow through the supply flow passage portion, working fluid to be supplied into the fluid cylinder; and
a discharge flow passage portion configured to let, flow through the discharge flow passage portion, working fluid discharged from the fluid cylinder, and
the relief valve is disposed on the discharge flow passage portion.

3. The work vehicle according to claim 2, further comprising:
a check valve disposed on the supply flow passage portion and configured to permit working fluid to flow from a side of the control valve toward the fluid cylinder and prevent working fluid from the fluid cylinder from flowing toward the control valve.

4. The work vehicle according to claim 1, wherein
the control valve unit includes:
a pump port through which working fluid from the pump flows into the control valve unit;
a discharge port through which working fluid is discharged from the control valve unit; and
a cylinder port through which working fluid flows out of the control valve unit toward the fluid cylinder and through which working fluid flows from the side of the fluid cylinder into the control valve unit.

5. The work vehicle according to claim 1, further comprising:
an adjuster disposed on an outer wall of the control valve unit and configured to adjust a relief pressure of the relief valve.

6. The work vehicle according to claim 5, further comprising:
a transmission case at a back portion of the body,
wherein the control valve unit is fixed to a lateral portion of the transmission case in such a manner that the adjuster faces backward relative to the body.

7. A work vehicle, comprising:
a body;
a carrier box provided for the body and configured to be lifted and lowered;
a fluid cylinder configured to operate the carrier box, the fluid cylinder including:
a first working fluid chamber; and
a second working fluid chamber;
a pump configured to supply working fluid into the fluid cylinder; and
a control valve unit including:
a control valve configured to control supply and discharge of working fluid into and from the fluid cylinder;
a first supply and discharge flow passage between the control valve and the first working fluid chamber;
a second supply and discharge flow passage between the control valve and the second working fluid chamber;
a first relief valve disposed on the first supply and discharge flow passage and switchable between (i) a block position, in which the first relief valve blocks the first supply and discharge flow passage, and (ii) a relief position, in which the first relief valve permits working fluid to flow from a side of the first working fluid chamber toward the control valve; and
a second relief valve disposed on the second supply and discharge flow passage and switchable between (i) a block position, in which the second relief valve blocks the second supply and discharge flow passage, and (ii) a relief position, in which the second relief valve permits working fluid to flow from a side of the second working fluid chamber toward the control valve,
the control valve being switchable between
a first position, in which the control valve permits working fluid from the pump to be supplied into the first supply and discharge flow passage and working fluid from the second supply and discharge flow passage to be discharged,
a second position, in which the control valve permits working fluid from the pump to be supplied into the second supply and discharge flow passage and working fluid from the first supply and discharge flow passage to be discharged, and
a third position, in which the control valve blocks the first and second supply and discharge flow passages.

8. The work vehicle according to claim 7, wherein
the first supply and discharge flow passage includes:
a first supply flow passage portion configured to let, flow through the first supply flow passage portion, working fluid to be supplied into the first working fluid chamber; and
a first discharge flow passage portion configured to let, flow through the first discharge flow passage portion, working fluid discharged from the first working fluid chamber,
the first relief valve is disposed on the first discharge flow passage portion,
the second supply and discharge flow passage includes:
a second supply flow passage portion configured to let, flow through the second supply flow passage portion, working fluid to be supplied into the second working fluid chamber; and
a second discharge flow passage portion configured to let, flow through the second discharge flow passage portion, working fluid discharged from the second working fluid chamber, and
the second relief valve is disposed on the second discharge flow passage portion.

9. The work vehicle according to claim 8, further comprising:
a first check valve disposed on the first supply flow passage portion and configured to permit working fluid to flow from a side of the control valve toward the first working fluid chamber and prevent working fluid from the side of the first working fluid chamber from flowing toward the control valve; and
a second check valve disposed on the second supply flow passage portion and configured to permit working fluid to flow from the side of the control valve toward the second working fluid chamber and prevent working fluid from the side of the second working fluid chamber from flowing toward the control valve.

10. The work vehicle according to claim 7, wherein
the control valve unit includes:
a pump port through which working fluid from the pump flows into the control valve unit;
a discharge port through which working fluid is discharged from the control valve unit;
a first cylinder port through which working fluid flows out of the control valve unit toward the first working fluid chamber and through which working fluid flows from the side of the first working fluid chamber into the control valve unit; and
a second cylinder port through which working fluid flows out of the control valve unit toward the second working fluid chamber and through which working fluid flows from the side of the second working fluid chamber into the control valve unit.

11. The work vehicle according to claim 7, further comprising:
an adjuster disposed on an outer wall of the control valve unit and configured to adjust a relief pressure of the first relief valve; and
an adjuster disposed on the outer wall of the control valve unit and configured to adjust a relief pressure of the second relief valve.

12. The work vehicle according to claim 11, further comprising:
a transmission case at a back portion of the body,
the control valve unit is fixed to a lateral portion of the transmission case in such a manner that the adjusters face backward relative to the body.
